(19) United States
(12) Patent Application Publication
(10) Pub. No.: US 2009/0229135 A1
(43) Pub. Date: Sep. 17, 2009

(54) Door hardware installation tools

(76) Inventor: Arnold Ricardo Gilliam, Guilford County, NC (US)

Correspondence Address: Arnold R. Gilliam, 5505 Flinchum Ave, Julian, NC, 27283, US

(21) Appl. No.: 12/075,437

(22) Filed: Mar. 12, 2008

(51) Int. Cl. B25D 3/00; B27F 5/12

(52) U.S. Cl. 33/197; 30/167.1; 30/167.2

(57) ABSTRACT

The present invention is a special-pattern cutting tool for preparing mortises on the edges of wood door slabs and jambs to inset the various plates on standard door hardware. This wood-chisel type tool enables the finish carpenter to quickly cut an outline exactly matching the flat screw-plates that secure the hardware to the door-slab and jambs. The improvement is primarily the cut-pattern shape that incorporates a curved blade to match the rounded corners of said plates. Three variations of the tool comprise a set. Each one is intended to create an outline pattern matching the hinge plate, or the latch-bolt striker plate, or the latch-bolt/lock-bolt plunger plate according to the specifications of at least one manufacturer's door hardware products. Some industry standards do exist between manufacturers to enable competitive replacement of such hardware so the tools would be somewhat universal.

### REFERENCES CITED

### United States Patents

| | | |
|---|---|---|
| 1 2 5 1 6 9 3 | January, 1918 | Pummill |
| 2 7 1 9 6 1 8 | September, 1955 | Polkosnick |
| 5 0 6 7 5 3 7 | November, 1991 | Offner |
| 5 5 1 1 3 1 2 | November, 1994 | Hobbs, David W. |

### BACKGROUND AND DISCUSSION OF PRIOR ART

There are no tools commercially available to cut mortise insets for replacement door slabs and/or replacement wood-work in the field during installation that will accommodate the radius corners of hardware. These hardware items with rounded corners have been purposely developed over the years to match the hinge mortise produced by automated routing equipment. On a mass production scale it is worth the investment to cut these insets using specialized routing equipment and permanent fixtures or CNC Machine programs. Said computer numerically controlled machinery is employed for nearly all factory operations nowadays where door units are manufactured. The cutting bits are round and leave round corners. Clearly it was less expensive to modify the hardware than to add expensive operations to accommodate the old square corner styles. The smaller striker plate mortises have sharper radius corners than the door hinges but their corners are rounded and the principle is the same.

The finish carpenter when replacing a door slab or door jamb, when said rounded corner hardware has been used in the rest of the building, is left with the tedious job of tracing the various mounting screw-plates of the hardware onto the surfaces and either chiseling out a square corner as in prior art or trying to make a series of smaller chisel cuts approximating the curved shape. Both techniques leave a sloppy appearance.

All tools in the prior art for generating these mortised insets have been and are intended to accomplish the following work while in the field:
1. They are to enable the craftsman to accommodate various sizes of hinge plates while consistently reproducing the mortise for that chosen size inset in several locations on a door or a mating jamb.
2. The tools must gauge and hold the mortise in specified positions: at least laterally across the edge face of a door and also, in some cases either by measurement or by gauge, fix the position longitudinally (height) to match existing work.
3. Efficiently control the proper depth and quality of workmanship when chiseling out the material in the mortise by hand or by electric router.
   There is a broad variety of tools and processes specified in the prior art to do this but they all have been designed to precisely accommodate the square corner butt hinge. Most are comprised of many parts and those that are used in conjunction with hand routers are fixtures to guide the cutting path and depth; in such cases the prior art specifies the added work to “square out” the resultant round corners to match hardware.

All tools except ONE appear to be expensive, complex, and require excessive set-up. The most practical tool for the work described above is a simple formed piece of steel that has been sharpened into a three blade chisel, closely resembling the present invention, and functioning the same as certain components specified in prior art. Said pattern-cutting components are placed on the wood door or jamb, in the proper location according to measurements, markings, or gauges then firmly struck with a hammer sufficient to create an outline that matches the hinge plate. The only problem is that the corners of the outline in all prior art are SQUARE.

This simple one-piece tool is not specifically recorded in prior art, and neither is it sold under patent protection. But it has been around for years and certainly falls within the scope of previous claims that deal with rectangular insets. Such claims date back to 1919. and are no longer protected by patent.

More importantly there are no such tools for the smaller striker plates and latch-bolt/lock-bolt plunger plates. In conclusion, there is a serious need for tooling to efficiently cut the same shallow mortise insets for ROUNDED CORNER hinges as well as the other two hardware items mentioned above; all have rounded corners and are not accommodated in the prior art.

### SUMMARY OF THE INVENTION

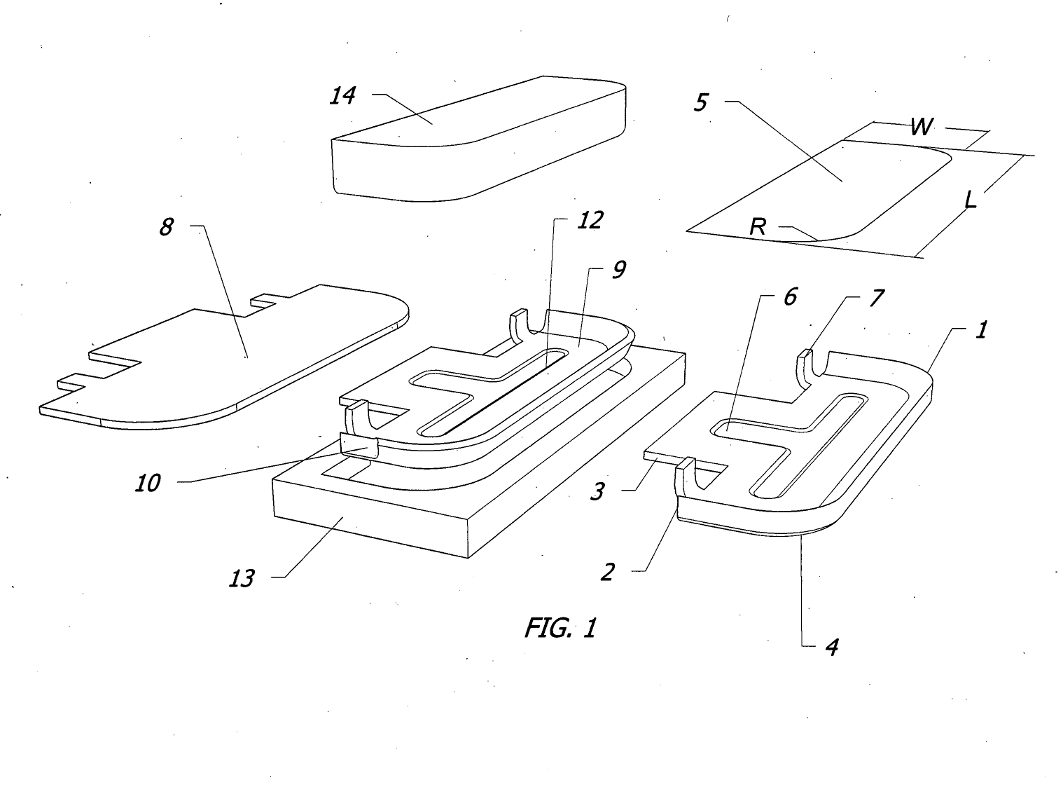

The preferred embodiment of the invention can most easily be defined in terms of the following manufacturing process:
1. Three steps in a progressive punch-press die to:
   a. blank-out a flat piece of ductile material into a flat, essentially rectangular T-shape except having two rounded corners at the top of the T-shape and an edge of substantial thickness, said material being brass or ductile steel that might gain toughness and longer edge life from stress forming or heat treatment, the extent of which is not significant to the claims and may be determined later;
   b. formed or drawn along the three outside edges of the top portion of the T-shape, including the rounded corners, along with an embossed stiffener rib on its flat face and two locator gauge tabs formed on the two short edges on either side of the stem of the T-shape;
   c. and then, finally the rough tool being cut-off or sheared from the coil stock behind the handle, said handle extending from the back edge of the tool head, essentially comprising the stem of said T-shape.
2. The above action forms a three dimensional body (said “rough tool”) comprising three upturned sides contiguous with two right-angle corners, said corners having an obvious radius instead of the sharp corners common to a rectangular box; or in other words, a stiff formed three sided thick walled shallow partial-cup or pan shaped body, ready for the sharpening operation.
3. The two upturned gauge tabs on said back edges each comprise about 30% of the length of said edges and each have been placed near the end of that side. Said gauges are to serve as significant locator points during the milling operation and to dictate the precise relationship of an edge of the subject wood-work to the sharp curved edge, said edge having been milled to precise dimensions; see drawing labeled “FIG. 1” depicting partial mill cut [10] and final chisel edge.
4. Possible heat treatment to harden and preserve the edge, if needed.
5. Possible final grinding to create a fine wood-chisel type edge. (cost vs. benefit?)

The entire tool could also be milled from solid bar-stock to create the desired shape of the cutting edge [1], the appropriate gauge tabs [7], and a stable tool body for these essential features. This would involve considerably greater waste of material.

An alternate process would create the rough tool body from die-cast or injection molding using modern high-tech materials such as impact resistant, fiber reinforced poly carbonates. This would be followed by final grinding to create the sharp chisel-type edge around the desired pattern similar to milling operation above.

A second alternate would be to create a continuous band of knife-edge material similar to the razor blades in disposable shavers. This material would be pre-formed according to the cut patterns included with this specification and preserved in some impact resistant polymer that could be cast or injected into the proper mould. And finally, said pre-formed blade stock instead might be welded to a metal plate to preserve its shape and stability when being driven into the wood.

Admittedly, all of the alternative processes to achieve the shape, size, gauging, and stability necessary to be a useful tool in the field are far too costly and therefore impractical. They are included here to preclude someone having ordinary skill in this art from slightly changing the shape or design details but creating the same essential tool.

### BRIEF DESCRIPTION OF THE DRAWINGS

### 7-Sheets

FIG. 1 A perspective view of the Preferred Embodiment for Door Hinge Plates.

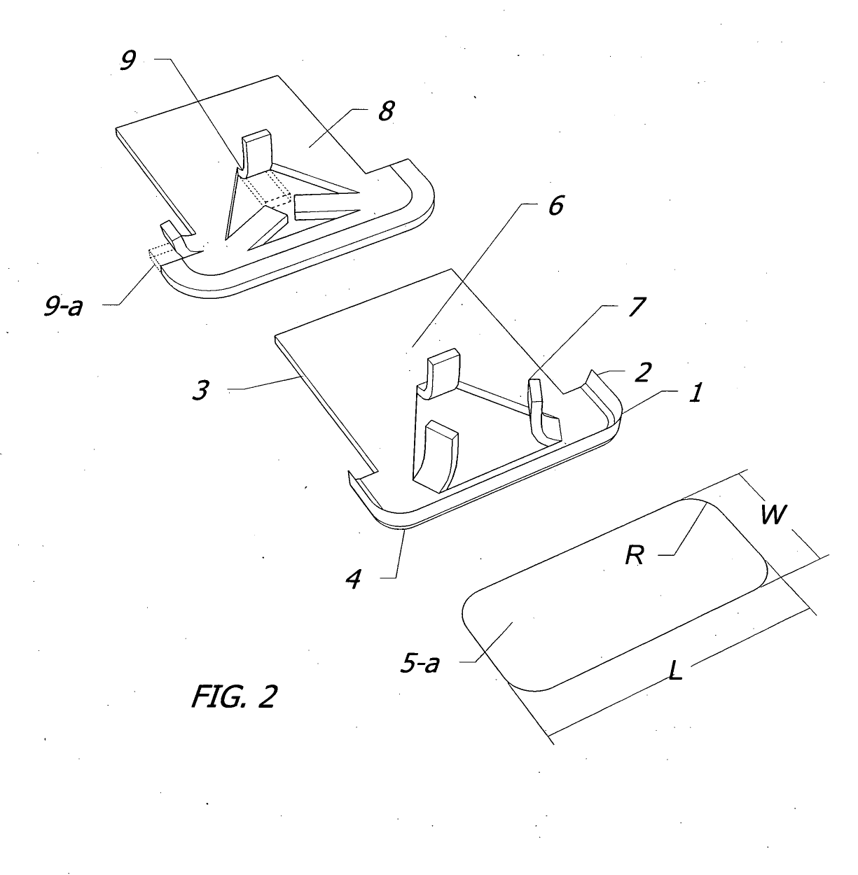

FIG. 2 Perspective view of the Latch-bolt/Lock-bolt Plunger Plate Tool.

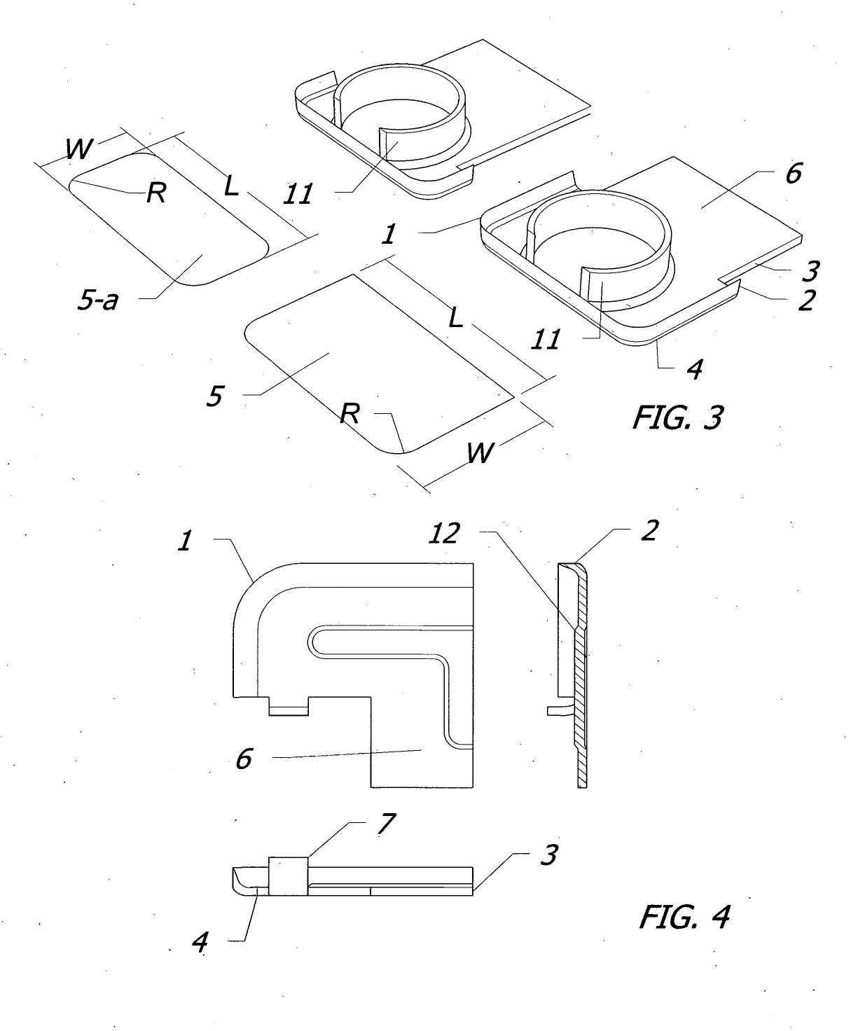

FIG. 3 Perspective view of the Striker Plate Tool.

FIG. 4 Cut-away cross-section, elevation, and plan view of Hinge Plate Tool.

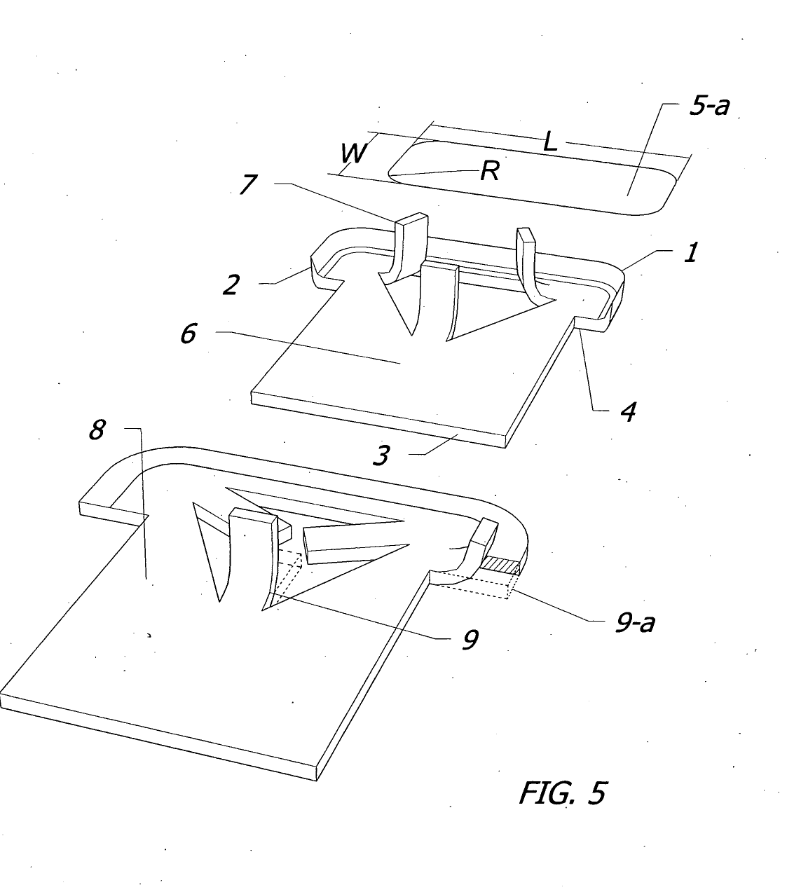

FIG. 5 Same as FIG. 2 except emphasis on intermediate stages of process.

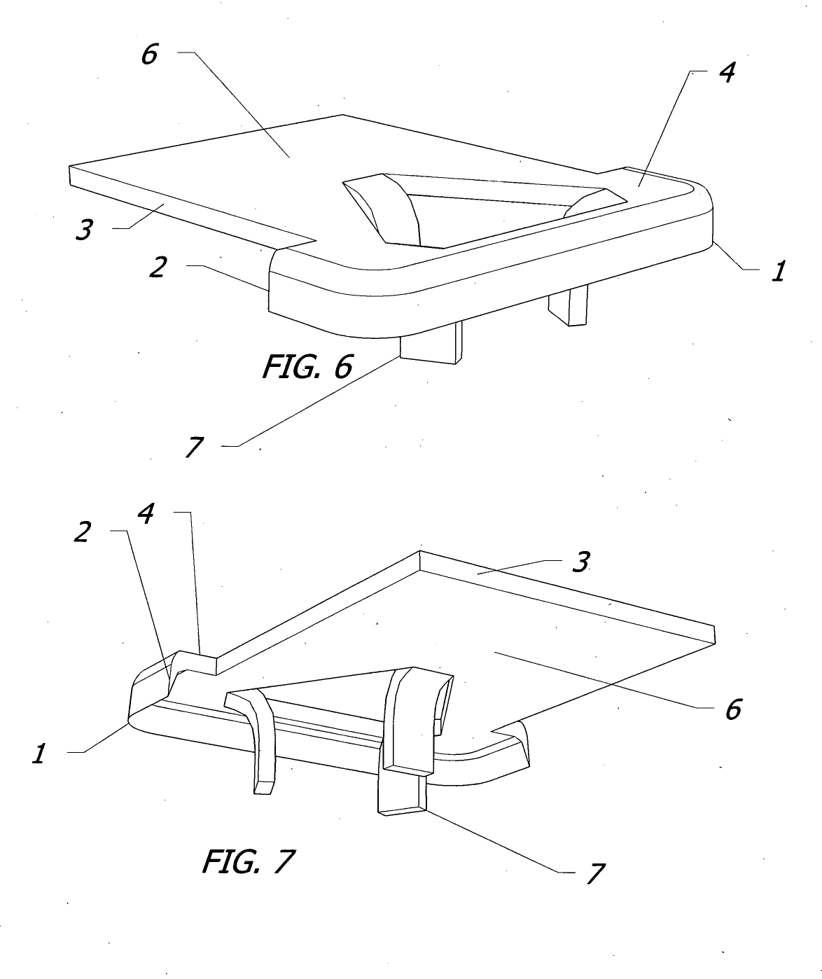

FIG. 6 Similar to FIG. 2 except clear view of the striking surface on that tool.

FIG. 7 Similar to FIG. 2 except clear view of the cutting face/edge on that tool.

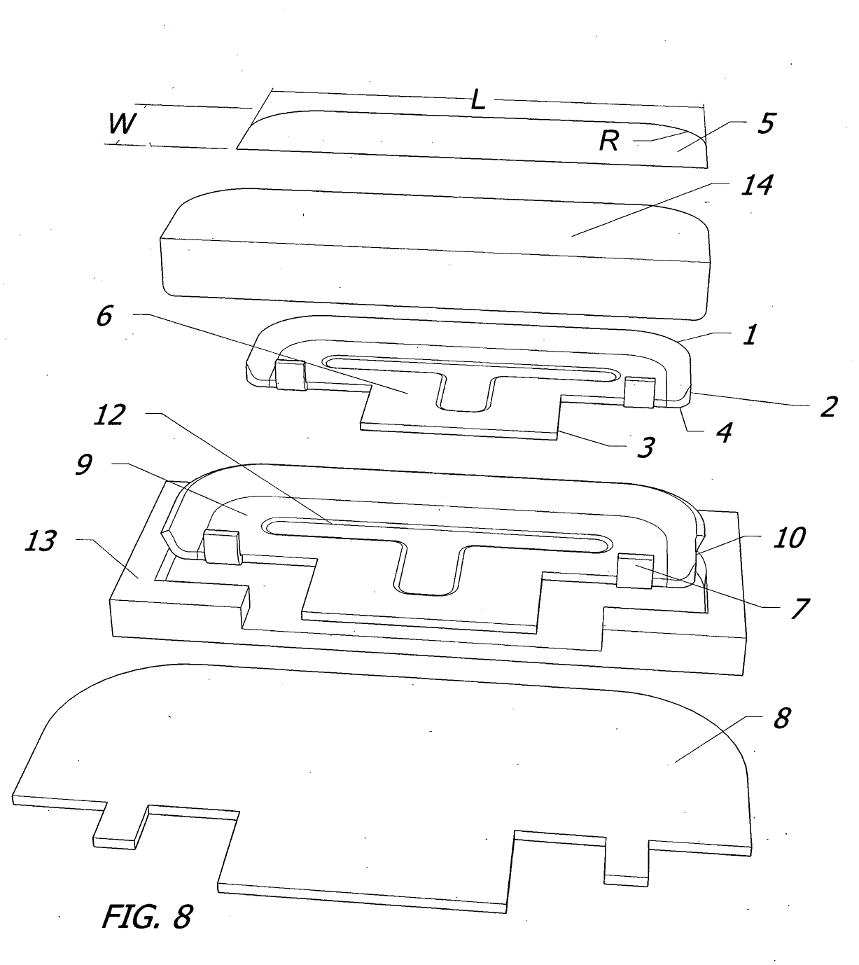

FIG. 8 Same as FIG. 1 except emphasis on intermediate stages of tool in process.

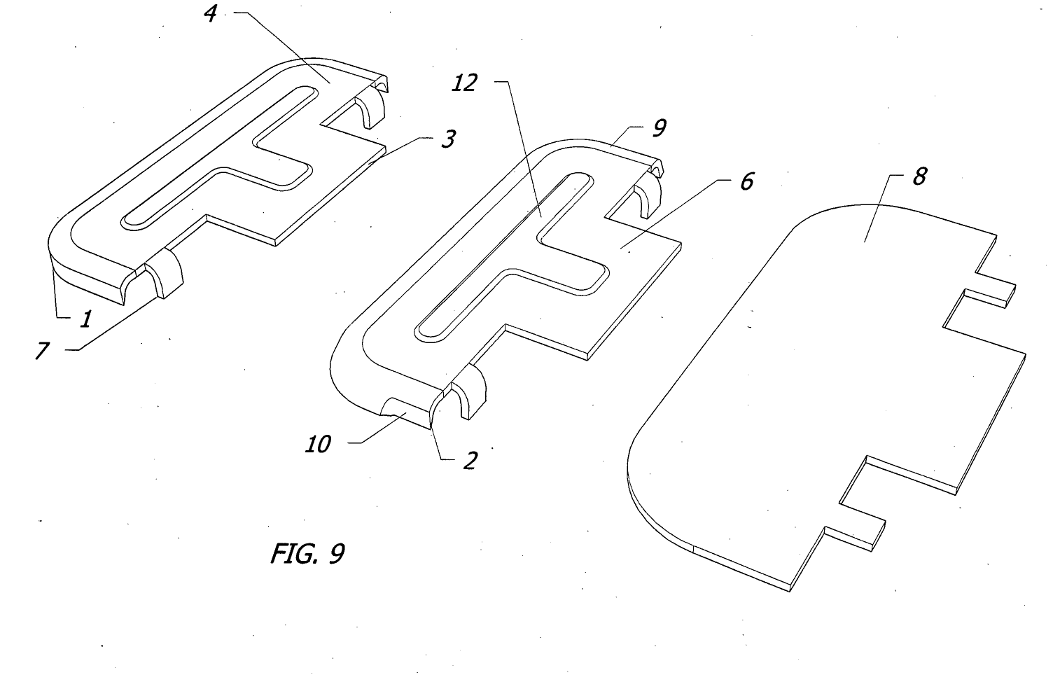

FIG. 9 Same as FIG. 1 except clear view of the striking surface on that tool.

### DETAIL DESCRIPTION OF THE PREFERRED EMBODIMENT

FIG. 1 depicts both the finished tool for the door hinge plate and the intermediate forms [8] and [9] it must pass through to be completed. The initial milling cut-away [10] shows how the edge of the rough/formed tool [9] is to be transformed into the finished curved cut-edge [1]. The curved radius [R] on the pattern corners is the essential improvement over prior art; the length [L] and width [W] reflect the standard sizes in the industry for door hardware, said sizes being depicted in the cut-pattern [5]. Said curved cutting edge [1] matches said cut-pattern and is shown as a sharp chisel edge. The cut-depth [2] is crucial and accurately reflects the depth of the resulting inset in relation to the overall tool size. The striking surface [4] serves as a way to accomplish the work with precision and control, said work being two or three carefully delivered hammer blows. The thickness [3] is also crucial to ensure stability of the tool body and provide sufficient material for creating the up-turned cutting edge, said stability also being provided by the embossed rib [12] formed in the main body of said tool. The handle [6] provides the means to place the tool as needed, keeping hands out of harm's way during use. Finally the locator/gauging tabs [7] insure the resulting inset will match the two halves of the hinge on both the door jamb and the door slab in relation to the width [W] of standard hardware.

FIG. 2 Illustrates the Latch-bolt/Lock-bolt Plunger Plate Tool features [1] thru [7]. This version of said invention must be used in two positions and cuts only half of the inset pattern [5-a] at a time so as to provide a handle [6] and accessible striking surface [4]. The left hand position is shown here. The same curved cutting edge [1], cut-depth [2], and thickness [3] are also shown. The cut pattern [5-a] matches industry standards, similar to said hinge-plate, for length [L] and width [W], with the exception of a tighter radius [R]. Just as in FIG. 1, said blank [8] and two partial sections of formed surfaces [9] and [9-a] are shown to help visualize critical features of the rough-tool stage; see FIG. 5 to clarify this. Said formed gauge tabs [7] must be and are shown protruding above the cut-depth [2] of said tools both in FIG. 1 and FIG. 3. Said tabs have been arranged in FIG. 3 to approximate a circle and serve to position said Latch-bolt tool relative to a latch-bolt hole that will have been bored into door edge prior to the work to be done by the present invention.

FIG. 3 Includes the Striker Plate version of the present invention along with the Latch-bolt tool from FIG. 3 in the background shown in the right hand position. The same features identified in previous drawings, namely curved cutting edge [1], cut-depth [2], thickness [3], striking surface [4], and handle [6] are depicted in said Striker Plate tool; but an alternate type of locator gauge [11] in the shape of a partial ring is shown on both said Striker Plate tool and on said right hand position of said Latch-bolt Plunger Plate tool. Said partial ring gauge would be welded or affixed by other means to the main body of said tools in lieu of the punched and formed tabs [7] shown on previous drawings. In addition, see how the noticeably larger width [W] on the pattern [5] for the industry standard door latch striker plate compares to the nearby pattern [5-a] for the plunger plate; both have the same length [L] and radius corner [R] said width dictating the size of said Striker tool.

FIG. 4 Shows a cut-away section of said Hinge Plate Tool in FIG. 1 along with orthogonal projections of plan and elevation. Features [1] thru [4] are identified to those in FIG. 1 along with said handle [6] and gauge tab [7]. Note that said stiffener rib [12] has been illustrated with a concave bulge as opposed to the convex bulge shown in FIG. 1; either direction will work and both are included with this specification.

FIG. 5 Shows the same tool as FIG. 2 except with emphasis on the punched out blank [8] and two partial formed sections [9] and [9-a]. The formed curved edge which precedes the milling operation that generates said curved cutting edge [1], is not depicted in its entirety; instead, only a small section [9-a] is shown in said formed position and only one of the three tabs [7] is likewise formed up. Both examples [9] and [9-a] only serve to illustrate the characteristics of the second intermediate stage, similar to the second stage of said larger hinge plate tool in FIG. 1.

FIG. 6 and FIG. 7 show said Latch-bolt tool in two positions to depict, in left orientation, the striking surface [4] which receives said hammer blows, and the cutting edge [1] or bottom side of said tool, shown in right orientation. The other essential features, cut-depth [2], thickness [3], handle [6], and gauge tabs [7] are shown on both FIG. 6 and FIG. 7.

FIG. 8 shows the same tool as FIG. 1 except with emphasis on the alignment of the intermediate stages as they move through a multi-stage punch/form die during manufacture. To that end, please note simulated representations of said die cavity [13] and forming punch [14]. All the other features of the present invention, details [1] thru [10] along with stiffener-rib [12] are identified the same as in previous drawings but this view is primarily to illustrate that a very efficient manufacturing process must be followed for this invention to be practical.

FIG. 9 shows the same tool as FIG. 1 except with emphasis on the position of said tool when being struck with a hammer, surface [4]. All other features of the present invention [1] thru [10] and [12] are identified, the same as in previous drawings.

1. I claim a woodworking tool, needed by finish carpenters in field operations for door hardware installation that embodies new and novel features, namely curved chisel-type cutting edges integrated with straight cutting edges, said tool being used to create a precise outline for a mortise/inset that accommodates industry-standard door hardware, by careful placement and striking with a hammer, said tool also comprising locator gauges, which are an integral part of said tool and thus held in proper relationship to said curved chisel-type cutting edge, said gauges making contact with wood-work surfaces to efficiently locate said tool laterally and enable the craftsman to create an exact cut pattern matching door hardware having rounded corners.

2. I claim a woodworking tool embodying all the same features of claim #1 except having a locator gauge, not formed from the same piece of material but rather affixed permanently by welding or other means such that precise placement of said cut pattern, relative to other physical features of the wood-work, will be the result when used in a the same manner as previously stated.

3. I claim a woodworking tool embodying all the same features of claim #1 except having an embossed stiffener rib spanning the middle region of the main body.
